(19) United States
(12) Patent Application Publication
(10) Pub. No.: US 2026/0303344 A1
(43) Pub. Date: Oct. 1, 2026

(54) METHODS AND SYSTEMS FOR ACCOUNT RECOVERY AND DEVICE AUTHENTICATION

(71) Applicant: Nulia.US Corp., Cheyenne, WY (US)

(72) Inventor: Nir Haim Arad, Snoqualmie, WA (US)

(21) Appl. No.: 19/631,864

(22) Filed: Mar. 27, 2026

Related U.S. Application Data
(60) Provisional application No. 63/779,826, filed on Mar. 28, 2025.

(51) Int. Cl. H04L 9/08; H04L 9/30; H04L 9/32

(52) U.S. Cl. CPC H04L 9/0894; H04L 9/0866; H04L 9/3073; H04L 9/321

(57) ABSTRACT

A technique is directed to methods and systems for QR-code based account recovery and device authentication. This system provides a secure method for managing user accounts and enabling recovery across multiple devices. The system combines trusted third-party authentication services with local key generation and encryption, ensuring that sensitive cryptographic material remains protected throughout the authentication and recovery processes. The system generates QR codes that encode critical recovery information, which can be stored offline as a physical backup for account recovery purposes.

### CROSS-REFERENCE TO RELATED APPLICATION

This application claims priority to U.S. Patent Application No. 63/779,826, filed Mar. 28, 2025 entitled “METHODS AND SYSTEMS FOR ACCOUNT RECOVERY AND DEVICE AUTHENTICATION,” which is hereby incorporated by reference in its entirety for all purposes.

### BACKGROUND

Secure data storage and account management have become increasingly important in the digital age. Multi-factor authentication has emerged as a popular method to enhance security. Third-party authentication services have become prevalent, allowing users to leverage their existing accounts with trusted providers for authentication across multiple platforms. However, the commonly available solutions do not always address every type of attack vector, and every functional need of a computer system.

### BRIEF DESCRIPTION OF THE DRAWINGS

FIG. 1 is a flow diagram illustrating a method of creating an account in accordance with various embodiments of the present technology.

FIG. 2 illustrates a diagram for device authentication in accordance with various embodiments of the present technology.

FIG. 3 is a flow diagram illustrating a method of generating a quick-response (QR) device key pair in accordance with various embodiments of the present technology.

FIG. 4 illustrates a diagram for creating a QR code in accordance with various embodiments of the present technology.

FIG. 5 illustrates a diagram for user re-authentication and account recovery via a QR code in accordance with various embodiments of the present technology.

FIG. 6 is a block diagram illustrating an overview of devices on which some implementations can operate.

FIG. 7 is a block diagram illustrating an overview of an environment in which some implementations can operate.

FIG. 8 is a block diagram illustrating components which in some implementations can be used in a system employing the disclosed technology.

FIG. 9 illustrates a user interface for displaying and managing recovery codes for account access, configured in accordance with various embodiments of the present technology.

The techniques introduced here can be better understood by referring to the following Detailed Description in conjunction with the accompanying drawings, in which like reference numerals indicate identical or functionally similar elements.

### DETAILED DESCRIPTION

Aspects of the present disclosure are directed to methods and systems for machine-readable code-based account recovery and/or device authentication. More specifically, it discloses a method and system for account recovery and multi‐device authentication using machine-readable codes (e.g., physical and/or virtual machine-readable codes). The machine-readable codes can be locally generated QR codes in conjunction with trusted third‐party authentication services (e.g., OAuth with Google). The account recovery system can employ a dual-factor security model combining “something you know” (e.g., a trusted online identity) and “something you have” (e.g., a physical QR code) to enable secure recovery of a user’s private cryptographic key without ever exposing the key in unencrypted form on any remote server. The account recovery system can be applied to various types of accounts and digital assets, including but not limited to trust accounts, banking accounts, cryptocurrency wallets, real estate holdings, investment portfolios, retirement accounts, insurance policies, digital asset repositories, social media accounts, email accounts, cloud storage accounts, healthcare records, legal documents, and estate planning materials.

In some embodiments, when a user registers for an account with the account recovery system, a unique user key pair (public/private) is generated, and the user’s public key is stored on a cloud server. To increase security, the user’s private key is never stored in plain text, but instead, is encrypted locally on a user device (e.g., any electronic device, such as a laptop, tablet, smartphone, desktop computer, etc.) with a device public key before being transmitted to and stored by the cloud server.

After the user’s account is created, the user can authenticate one or more user devices using a trusted online authentication service (e.g., OAuth with Google). On each device, a device-specific key pair is generated locally. Each user device encrypts the user’s private key using its own device’s public key and transmits the encrypted key to the cloud server. In some embodiments, if the user logs out of the device, the user’s private key may be deleted from the device; if the user logs in again, the device downloads the key from the server, and uses its own private device key to decrypt the user’s private key. Furthermore, in case device A is lost or stolen, the user may use another device B in their possession to delete the key for device A and remotely force it to log out, effectively blocking third parties from accessing the user’s data on the lost device. In some embodiments, the number of keys can be limited or set by the user.

When the user opts to create a physical backup, the user device can generate a new “QR device” key pair. The user device can locally encrypt the user’s private key with the QR device's public key. The user device can transmit the QR device public key and a unique QR device identifier to the server along with the encrypted user’s private key. The user device can generate a QR code that encodes the QR device identifier together with the QR device’s private key. This QR code is then stored offline (e.g., printed on paper or another medium, screenshot stored by a hard drive/portable storage device, etc.) as a backup.

For account recovery, if a user device is lost, the user can be re-authenticated on a new device using the QR recovery code. The new device can locally restore a user’s private key without receiving or transmitting an unencrypted form of the user’s private key on a remote network, unsecured network, etc. A user can scan the stored QR code to authenticate the new device. The new user device can extract one or both of the QR device’s private key and identifier from the QR code. The new user device can contact the server to retrieve the corresponding encrypted user private key. The user device can use the QR device's private key to decrypt the encrypted copy locally, thereby restoring the user’s private key without ever exposing it in unencrypted form on a network, the cloud, etc. The user is not required to use the same third-party account when recovering their data. For example, the system accommodates users who lost access to their Google or Apple account, and need to access their plan with a new email account, by recovering with the QR code. Once data access is recovered, the user can re-authenticate on that device using the third-party authentication, and without having to use the QR code again.

As described in detail below, at least some implementations of the present technology can provide one or more technical advantages over conventional technology. Firstly, the account recovery system provides a secure method to transfer or handover access to account data between different third-party accounts and between devices, while maintaining end-to-end encryption and zero-knowledge principles. Secondly, the account recovery system provides local encryption due to all the encryption operations being performed on the user device, thus ensuring that the cloud server never accesses the unencrypted user private key.

Thirdly, the account recovery system can utilize different cryptographic methods, such as Elliptic Curve Cryptography, and post‐quantum cryptographic algorithms. While the processes described herein are based on public key methods, they can be adapted to other cryptographic systems, like post-quantum cryptography. In an example, the account recovery system provides the user with the ability to recover their private key using the physically stored QR recovery code in the event of losing a device. In another example, the account recovery system provides the user with a recovery method if the user loses access to their email (with the third-party authentication service) or switching between one third-party authentication service and another (e.g., switch from Apple to Google).

Fourthly, the account recovery system provides credential management for users to manage, regenerate, or revoke device credentials and QR recovery codes as needed. Several implementations are discussed below in more detail in reference to the figures. Existing multi-factor authentication methods cannot fully accommodate the security requirements of that system.

At least some embodiments of the present technology is unique in protecting end-to-end encrypted, cloud-based user data repositories against isolated security incidents of each of the following types: device loss or theft, email account access loss or theft, and physical recovery device loss (but not theft). This protection is guaranteed while maintaining zero-trust principles, i.e., the user’s data is never exposed to the cloud service provider. In each of those cases, by using the present technology, the user will be able to restore access to their data and maintain or regain the ability to recover it.

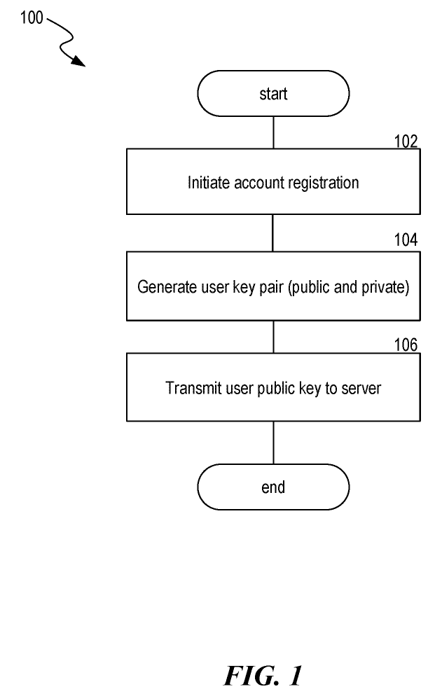

FIG. 1 is a flow diagram illustrating a method 100 of creating an account in accordance with various embodiments of the present technology. The method 100 is illustrated as a series of steps 102, 104, and 106. All or a subset of one or more of the steps 102, 104, and 106 can be executed in accordance with the description above and/or with the description that follows.

At step 102, a user can initiate, via a user device, the account registration process. This initiation can involve accessing a designated registration interface on a user device or other computing platform to register an account. A user can authenticate one or more user devices using one or more trusted online authentication services (e.g., OAuth with Google). The registration interface can present the user with options to select a preferred authentication provider and can guide the user through the necessary steps to establish their identity with the chosen service. In some implementations, the system can verify that the user device meets minimum security requirements before proceeding with the registration process, such as confirming the presence of secure storage capabilities for cryptographic keys.

At step 104, the user device generates a unique user key pair. The key pair can include a set of keys, such as a public key and a private key. The user device can generate the key pair locally, which can enhance security by ensuring that the private key never leaves the user device in an unencrypted form. The key pair generation can utilize cryptographic algorithms (e.g., Elliptic Curve Cryptography or other suitable methods) to create mathematically related public and private keys. The user device can employ a cryptographically secure random number generator to ensure the uniqueness and unpredictability of the generated key pair. Upon successful generation, the private key can be stored in a dedicated secure enclave or trusted execution environment available on modern devices to protect against unauthorized access.

At step 106, the user device transmits the public key part of the key pair to a remote storage device, cloud server, or other digital store system for storage. The public key can be used for various authentication and encryption processes within the system. In some cases, the public key is used by other users of the system to encrypt data that only the key pair’s owner can read. In some cases, the transmission of the public key in step 106 can be performed using secure communication protocols to protect against potential interception or tampering. The communication protocols can be selected by the user, determined based on the level of security for the account, or the like.

The user device can communicate with the cloud server and third-party authentication services via one or more wireless or wired networks. The wireless networks can include cellular networks (e.g., 4G LTE, 5G), Wi-Fi networks, satellite communication networks, or other wireless communication technologies. The user device can establish secure connections over these wireless networks using, for example, transport layer security (TLS) protocols or other encryption mechanisms to protect data in transit. When transmitting the public key or other sensitive information, the user device can verify the identity of the remote server through certificate validation to prevent man-in-the-middle attacks. The user device can also utilize network switching capabilities to maintain connectivity during the registration process, automatically transitioning between available wireless networks to ensure reliable communication with the cloud server and authentication services.

In some embodiments, the cloud server can store this public key in association with the user's account information for future use in authentication and encryption processes. The user device can retain the user private key in encrypted form, or in a dedicated encryption key secure storage area, available in modern devices. Throughout the method 100, the system can implement various security measures to protect the integrity and confidentiality of the user's cryptographic keys. For example, the private key generated in step 104 can be encrypted using a device-specific key before being stored on the user's device. This encryption can provide an additional layer of protection against unauthorized access to the private key. The method 100 can lay the foundation for secure account management and recovery in the QR-Code based system by establishing the user's cryptographic identity through the generation and secure storage of the key pair.

In some embodiments, the method 100 can be performed to authenticate the user device to access an account stored by a remote computer system. The authenticated user device can access data from the account based on one or more accessibility settings for a user associated with the authenticated user device. For example, the account can include one or more repositories storing data. In a read repository process, the user device can access and view the contents of repositories within, for example, a zero-trust version control system. The read repository process can connect to the user device to receive repository access requests and provide encrypted repository content to authorized users. The read repository process can include the decrypt data operation enabling the process to decrypt repository content for authorized users while maintaining encryption security for unauthorized access attempts. The read repository process can implement fine-grain access control mechanisms that verify user permissions for specific repository content and decrypt only the data objects that users are authorized to access. Example read repository processes, zero-trust version control systems, and related technologies are disclosed in U.S. App. No. 19/441,377, entitled ESTATE PLANNING PLATFORM WITH VERSION CONTROL AND ZERO TRUST SECURITY, which is incorporated by reference in its entirety. The accessibility settings can be authorization levels, data accessible to groups of authorized individuals using authorized devices, trigger events, automated notification settings, etc. For example, a user can authorize designated individuals to access relevant data (e.g., files, documents, etc.) stored in the account. The user can select groups of authorized individuals, data accessible to respective groups, authorization protocols, privacy settings, or the like. Authorized individuals (e.g., family members, coworkers, etc.) can access data to, for example, view personal data, manage assets, manage trusts, manage accounts (e.g., social media accounts, bank accounts, retirement accounts), or the like.

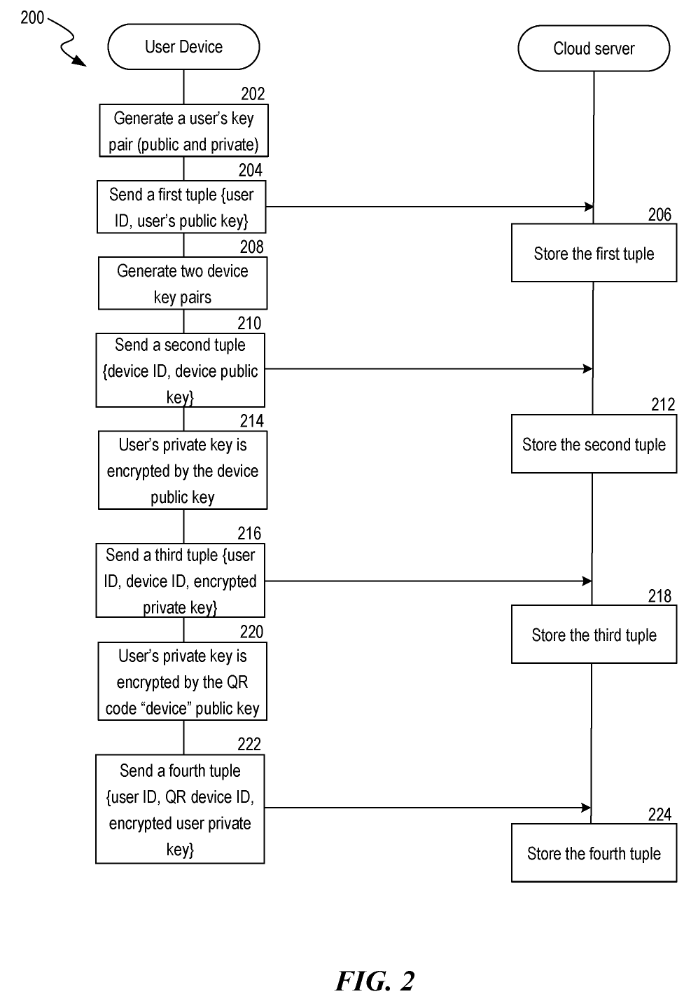

FIG. 2 illustrates a diagram 200 for device authentication in accordance with various embodiments of the present technology. The diagram 200 depicts the interaction between a user device and a cloud server during the device authentication and key management process. The diagram 200 is illustrated as a series of steps 202-224, which can be executed in accordance with the description above and/or with the description that follows.

At step 202, when an account is created, the user device, used in the account creation, generates a user’s key pair (e.g., private and public keys). This key pair generation can occur locally on the user device to enhance security by ensuring that the private key is created in a controlled environment. The generation process can utilize various cryptographic methods, such as Elliptic Curve Cryptography or other suitable algorithms.

At step 204, the user device sends a first tuple (e.g., user ID, user’s public key) to a cloud server. The user ID can be a unique identifier generated by the server to prevent conflicts. This transmission can be performed using secure communication protocols to protect against potential interception or tampering during transit. The first tuple establishes the user’s cryptographic identity on the server while keeping the private key securely stored on the user device.

At step 206, the cloud server stores the first tuple. The cloud server can associate the user’s public key with the user ID for future use in authentication and encryption processes. This stored information enables the server to verify the user’s identity and facilitate secure communications without ever accessing the user’s private key.

At step 208, the user device generates two “device key pairs”; one is for itself, and the other is for a QR code, which is treated as a “QR device”. Each device key pair includes a public key and a private key that are mathematically related. The generation of these key pairs locally on the user device ensures that the private keys are never exposed outside the device in an unencrypted form.

At step 210, the user device transmits a second tuple (e.g., device ID, device public key) associated with the device key pairs to the cloud server. The user device stores the device private key on the user device. This separation ensures that the cloud server can identify and authenticate the device using the public key while the private key remains securely stored locally for decryption operations.

At step 212, the cloud server stores the second tuple. The cloud server can associate the device public key with the device ID for future authentication and key retrieval processes. This stored association enables the server to verify device identity and provide the appropriate encrypted data when requested. The stored association may allow other user devices to fetch the device’s public key in order to establish device-to-device, end-to-end encrypted communications.

At step 214, the user’s private key is encrypted by the device’s public key. This encryption process can occur locally on the user device, ensuring that the unencrypted user private key is never transmitted over a network. The resulting encrypted private key can only be decrypted by the corresponding device private key, which remains securely stored on the user device.

At step 216, the user device transmits a third tuple (e.g., user ID, device ID, encrypted private key) to the cloud server. This transmission can be performed using secure communication protocols to protect the integrity of the encrypted data. The third tuple enables the cloud server to store the user’s private key in encrypted form, which can be retrieved later for account recovery or multi-device authentication.

At step 218, the cloud server stores the third tuple. The cloud server associates the encrypted private key with both the user ID and device ID for future retrieval. This storage enables the system to provide the encrypted private key to the authorized device when needed for authentication or recovery purposes.

At step 220, the user’s private key is encrypted by the QR code “device” public key. This encryption process occurs locally on the user device, maintaining the security principle that the unencrypted private key is never exposed outside the device. The QR device public key encryption creates a separate encrypted copy of the user’s private key that can only be decrypted using the corresponding QR device private key.

At step 222, the user device transmits a fourth tuple (e.g., user ID, QR device ID, encrypted user private key) to the cloud server. A fifth tuple (e.g., user ID, QR device ID, QR device private key) is stored on the QR code. This dual storage approach enables account recovery by combining the encrypted private key stored on the server with the QR device private key encoded in the physical QR code. U.S. App. No. 19/441,377, entitled ESTATE PLANNING PLATFORM WITH VERSION CONTROL AND ZERO TRUST SECURITY discloses QR codes that can be, for example, printed onto paper to generate a physical QR code.

At step 224, the cloud server stores the fourth tuple. The cloud server associates the QR-encrypted user private key with the user ID and QR device ID for future account recovery operations. This stored tuple enables the system to provide the encrypted private key when a user initiates recovery using the physical QR code backup.

### QR Recovery Code Generation

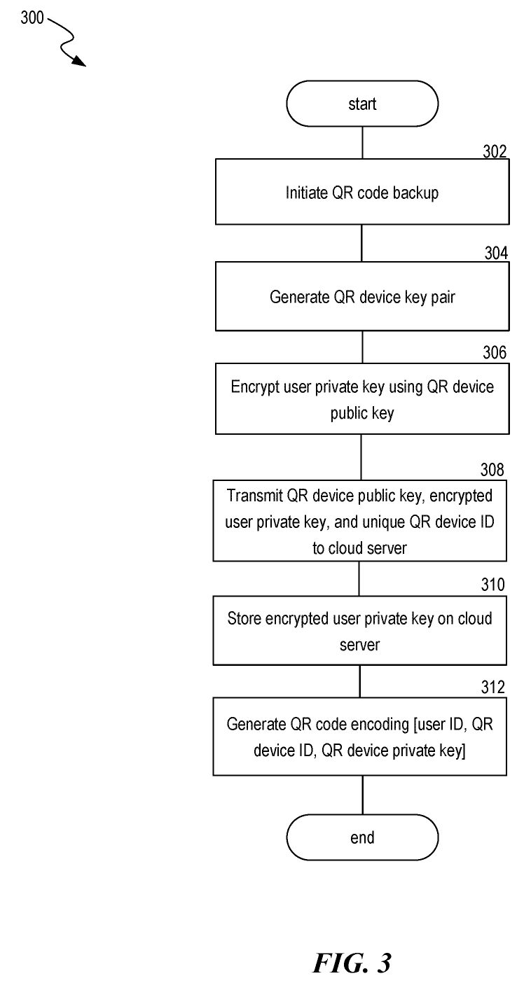

FIG. 3 is a flow diagram illustrating a method 300 of generating a machine-readable recovery code in accordance with various embodiments of the present technology. The method 300 is illustrated as a series of steps 302-312. All or a subset of one or more of the steps 302-312 can be executed in accordance with the description above and/or with the description that follows.

At step 302, a user device initiates the local QR recovery code process. This initiation can involve the user selecting an option within the system's interface to locally create a new QR recovery code. The user device can present a confirmation prompt to ensure the user intends to generate a new recovery code. The initiation process can also include verifying that the user is properly authenticated before proceeding with the QR code generation workflow.

At step 304, the user device generates a new QR device key pair. This QR device key pair can include a QR device public key and a QR device private key. The generation of these keys can occur locally on the user device to enhance security by ensuring that the QR device private key is not transmitted from the user device in an unencrypted form. The key pair generation can utilize cryptographic algorithms such as Elliptic Curve Cryptography or other suitable methods to create mathematically related public and private keys. The user device can employ a cryptographically secure random number generator to ensure the uniqueness and unpredictability of the generated key pair.

At step 306, the user device encrypts the user's private key using the QR device public key. This encryption process can occur locally on the user device, ensuring that the user's unencrypted private key is never exposed outside the device. The encryption operation creates a ciphertext that can only be decrypted by the corresponding QR device private key, which will be encoded in the QR code. This approach maintains the zero-knowledge principle by ensuring that the cloud server only receives and stores the encrypted version of the user's private key.

At step 308, the user device transmits the QR device public key, encrypted user private key, and a unique QR device identifier to a cloud server. The transmission of this data can be performed using secure communication protocols to protect against potential interception or tampering. The unique QR device identifier can be generated using, for example, a combination of random values and device-specific information to ensure uniqueness across the system. The cloud server can acknowledge receipt of the transmitted data and associate the QR device public key with the user's account for future recovery operations.

At step 310, the cloud server stores the encrypted user private key associated with the QR device identifier. This association can allow for future retrieval of the encrypted user private key using the QR device identifier as a reference. An example outcome of method 300 is that the server can invalidate a QR code by deleting the corresponding encrypted user private key. In a first example, the generation of a QR code automatically triggers the invalidation of old QR codes by the server, so there is always at most one active QR code. In a second example, the system provides users with an ability to manage their devices and QR codes, and multiple active recovery codes.

At step 312, the user device generates a QR code (e.g., model 1 QR code, model 2 QR code, micro QR code, IQR code, etc.). This QR code can encode the user ID, the QR device identifier, and the QR device private key. By including the QR device identifier and the QR device private key, the QR code can provide a comprehensive account recovery solution. The QR code can be associated with, linked to, and/or contains all or a portion of the QR device identifier and the QR device private keys. For example, the user device can use information obtained from the QR code to generate the QR device identifier and the QR device private keys.

In some cases, the QR code generated in step 312 is stored offline as a physical backup. This offline storage can involve printing the QR code on paper or on other media such as a fireproof metal plate, or saving a screenshot of the QR code on an offline memory device (e.g., portable hard drive, memory stick, etc.). The term "offline" refers to a state in which a storage medium is not electronically connected to any computing device, network, or communication system. For example, a printed paper copy of the QR code is inherently offline because it exists as a physical medium that cannot be accessed, modified, or compromised through electronic means. Similarly, a portable storage device such as a USB drive or external hard drive is offline when it is physically disconnected from any computer, server, or network-connected device. This physical disconnection ensures that the stored data remains inaccessible to remote attackers, malware, or unauthorized network access attempts.

Advantageously, when the offline memory device is in an offline storage state, the contents cannot be accessed via a computing system, thereby preventing remote access to the data. The offline storage approach provides an air-gapped security layer that protects the recovery information from cyber threats, including hacking attempts, ransomware attacks, and unauthorized surveillance. Users can store the printed QR code in a secure physical location such as a safe, safety deposit box, or other protected environment where physical access controls can be implemented. For electronic offline storage, the portable storage device can be stored in a similar secure location and only connected to a computing device when account recovery is necessary. This offline storage methodology ensures that the recovery private key encoded within the QR code remains protected through physical security measures rather than relying solely on digital security protocols. The offline memory device can be brought online by electronically connecting the memory device to a computing device, thereby enabling access to its contents. The physical nature of this backup can provide an additional layer of security, as the recovery information can be stored separately from the user's digital devices.

In some implementations, the QR device identifier can be generated by the cloud server rather than by the user device. When the user device initiates the QR recovery code generation process, the user device can send a request to the cloud server to obtain a unique QR device identifier. The cloud server can generate this identifier using a centralized identifier generation system that maintains a registry of all previously assigned identifiers. This server-side generation approach can ensure that each QR device identifier is globally unique across the entire system, eliminating the possibility of identifier collisions that could occur when multiple user devices independently generate identifiers.

The server-generated QR device identifier can provide one or more advantages over client-side generation. When multiple user devices generate identifiers independently, there exists a risk that two devices could generate identical or conflicting identifiers, particularly in systems with large numbers of users and devices. Such conflicts could result in authentication failures, data retrieval errors, or security vulnerabilities where one user's encrypted private key could be inadvertently associated with another user's QR device identifier. By centralizing the identifier generation on the cloud server, the system can maintain a single authoritative source for identifier assignment, implement collision detection mechanisms, and ensure that each identifier is unique before it is assigned to a QR device. The cloud server can utilize techniques such as universally unique identifiers (UUIDs), sequential numbering with namespace prefixes, or cryptographic hash-based identifiers to generate identifiers that are both unique and unpredictable.

In some implementations, the QR code generated by the user device can be encrypted for additional protection before being stored offline. The user device can apply an additional encryption layer to the QR code data using a user-selected passphrase, biometric-derived key, or device-specific encryption key. When the user needs to recover their account, the user device can decrypt the QR code by prompting the user to provide the corresponding passphrase or biometric authentication, thereby revealing the underlying recovery information. This additional encryption layer provides protection against unauthorized use of the QR code if the physical backup is discovered or stolen by a malicious actor. The encrypted QR code can be automatically linked to a specific device or set of devices, ensuring that only authorized devices possessing the appropriate decryption credentials can utilize the recovery code. The system can maintain a registry that associates each encrypted QR code with the devices authorized to decrypt and use it, preventing unauthorized devices from completing the recovery process even if they obtain the physical QR code.

The cloud server can implement a key management system that manages the number of QR device identifiers and device credentials associated with each user account. The key management system can enforce configurable limits on the number of active identifiers per user or per set of user devices, preventing excessive proliferation of recovery credentials that could increase security risks. When a user exceeds the configured limit, the system can automatically trigger deletion, deauthentication, or removal of the oldest or least recently used device credentials and associated encrypted keys. In some embodiments, the server can also reject new codes from being stored until the user deletes some of the old codes. The cloud server can transmit notifications to the user when keys are deactivated, alerting the user to potential security events or administrative actions affecting their account access. The key management system can support group management of keys, enabling batch activation, deactivation, or revocation of multiple credentials based on predefined protocols or security settings. A cloud key manager component on the server can coordinate with a user device manager component on each user device to retrieve, validate, and encrypt keys according to the system's security policies, ensuring consistent key lifecycle management across all components of the account recovery system.

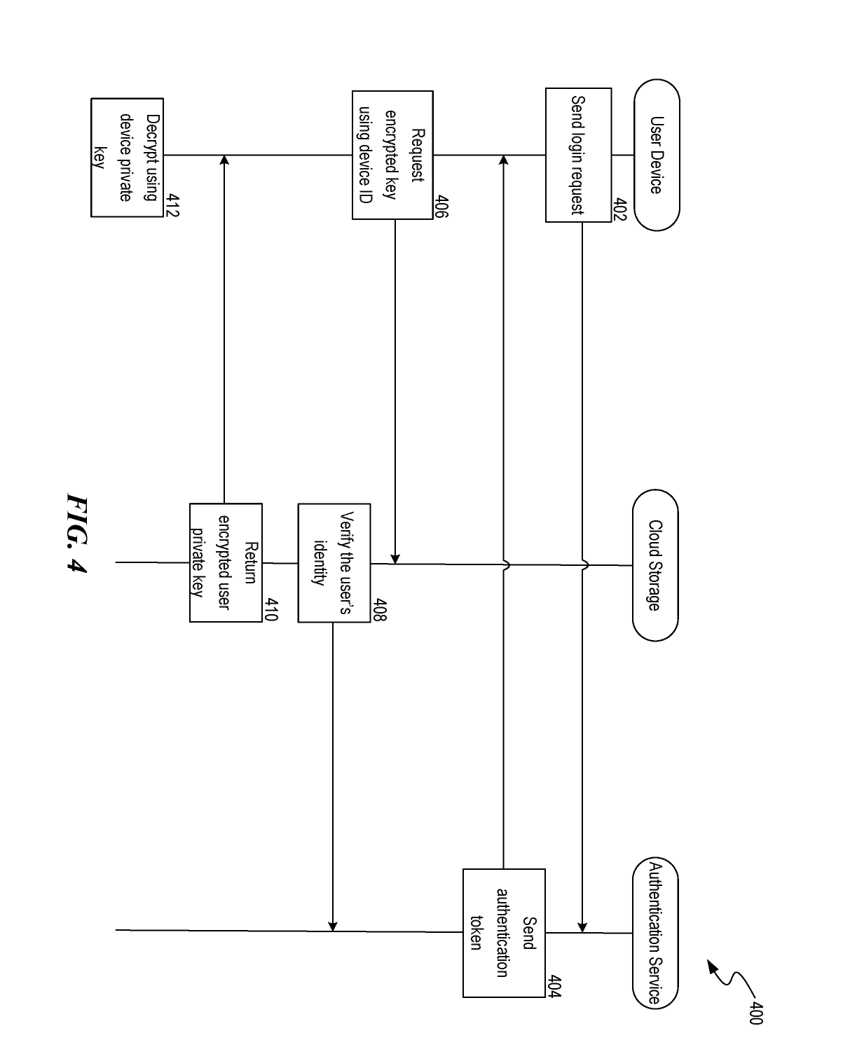

FIG. 4 illustrates a diagram 400 for creating a QR code in accordance with various embodiments of the present technology. The diagram 400 depicts a sequence of interactions between a user device, cloud storage, and an authentication service. The diagram 400 illustrates an authenticated device accessing a user’s data without utilizing a QR code. This process can occur when a user device has already been registered with the system and authenticated. The authenticated user device can possess the necessary device credentials to retrieve and decrypt the user's private key. The diagram 400 is illustrated as a series of steps 402-412, which can be executed in accordance with the description above and/or with the description that follows.

At step 402, the user device sends a login request to the authentication service. This login request can initiate the authentication process for an account recovery and include necessary credentials or identifiers to begin the verification. The login request can be transmitted using secure communication protocols to protect against, for example, potential interception and/or tampering during transit. The authentication service can be a trusted third-party provider, such as OAuth with Google or Apple, that maintains the user's identity credentials independently from the account recovery system.

At step 404, the authentication service sends an authentication token to the user device when the user is authenticated. This authentication token can serve as a temporary credential, allowing the user device to access secured resources or perform specific actions within the system. The authentication token can have a limited validity period (e.g., user selected period, system selected period, etc.) to enhance security and prevent unauthorized reuse of the credential. The token can be cryptographically signed by the authentication service to enable verification of its authenticity by other components in the system.

At step 406, the user device requests an encrypted key from the cloud storage. This request can include the device identifier, which can be used to locate the specific encrypted user private key associated with the user device. The request can also include the authentication token received in step 404 to verify that the requesting device has been properly authenticated. The cloud storage can use the device identifier to query its database and retrieve the corresponding encrypted user private key that was stored during the initial device authentication process.

At step 408, the cloud storage verifies the user’s identity with the authentication service. The authentication service can verify the user’s identity based on the authentication token (from step 404). This verification step ensures that the request for the encrypted key originates from a legitimately authenticated user and prevents unauthorized access to stored cryptographic material. The cloud storage can reject the request and terminate the process if the authentication service indicates that the token is invalid, expired, and/or has been revoked.

At step 410, the cloud storage sends the stored encrypted information to the user device. The encrypted information can include the user private key, wallet information, etc. The transmission of the encrypted information can be performed using secure communication protocols to maintain the integrity and confidentiality of the data during transit. Since the information remains encrypted throughout the transmission, the cloud storage maintains zero-knowledge principles by never accessing or exposing the unencrypted user private key.

Upon receiving the encrypted user private key, at step 412, the user device decrypts the user private key using the device private key. This decryption process can occur locally on the user device, ensuring that local decryption of the private key is maintained (e.g., the unencrypted user private key is never exposed outside of the device). The device private key used for decryption is stored on the user device. In some embodiments, the device private key can be stored in a dedicated storage area. For example, the storage area can be an accessible encryption key secure storage area configured for storing keys, encrypted data, etc. The decryption operation restores the user's private key to its original form, enabling the user to perform cryptographic operations such as signing transactions or decrypting user data.

The decryption in step 412 can utilize the device private key that corresponds to the device public key used for encryption during the initial device authentication process. By using this device-specific key pair, the system can ensure that only the authorized device can decrypt and access the user's private key. The successful completion of step 412 can grant the user device access to an account and associated data. The end-to-end encryption principles can ensure that the user's private key is only available in unencrypted form on the authorized user device. Following successful decryption, the user device can securely store the decrypted private key for future use in authentication and cryptographic operations within the system. The system or user can select a storage area for storing the decrypted private key.

In some implementations, the QR recovery code can be associated with a symmetric key rather than an asymmetric key pair. In this alternate implementation, a single symmetric key is generated locally on the user device and used to encrypt the user's private key. The symmetric key is then encoded directly within the QR code data alongside the QR device identifier. When the user scans the QR code during account recovery, the new user device extracts the symmetric key from the QR code and uses it to decrypt the encrypted user private key retrieved from the cloud server. This symmetric key approach simplifies the recovery flow by eliminating the need to generate and manage separate public and private keys for the QR device. The symmetric key implementation also reduces the amount of data stored on the cloud server, as the server only needs to store the encrypted user private key and the QR device identifier without requiring storage of a corresponding QR device public key.

The use of symmetric keys for QR recovery codes differs from the asymmetric key pair requirement for mobile devices. Mobile devices use asymmetric device key pairs to enable remote authentication of additional devices, as the device public key can be transmitted to and stored on the cloud server while the device private key remains securely on the device. This asymmetric approach allows the cloud server to encrypt data specifically for a particular device without ever possessing the means to decrypt that data. However, QR recovery codes operate differently because the recovery process involves physical possession of the QR code rather than remote device authentication. As a result, QR recovery codes cannot be treated by the server in the same manner as mobile devices and are managed separately within the system. The server maintains distinct handling logic for QR-based recovery credentials versus device-based credentials, recognizing that QR codes represent a physical backup mechanism rather than an authenticated computing device capable of participating in remote cryptographic protocols.

The system can determine whether to utilize symmetric keys or asymmetric key pairs based on, for example, the characteristics of the user device. For example, if the system determines the user device is a mobile device, the system can select an asymmetric key pair protocol for generating asymmetric key pairs usable by the mobile device. In some embodiments, the system determines the user device can locally generate and manage symmetric keys. The system can communicate with user devices to obtain information for determining whether the user device is compatible with particular keys.

In some implementations, the key generation process can be adapted based on the hardware capabilities and security features available on the user device. Computing devices can include specialized hardware components such as secure enclaves, trusted platform modules (TPMs), and hardware security modules (HSMs) that provide isolated execution environments for cryptographic operations. The key pair generation module can detect the presence of these hardware security features and utilize them to generate cryptographic keys within a protected hardware boundary, ensuring that private keys are created and stored in memory regions that are inaccessible to other software processes running on the device. This hardware-aware key generation approach can provide one or more technical improvements over software-only implementations. When a secure enclave is available, the device private key can be generated and permanently stored within the enclave, preventing extraction even if the device's operating system is compromised by malware. The system can also leverage hardware-based random number generators present in modern processors to ensure that generated keys possess sufficient entropy and unpredictability. Additionally, the key generation process can be configured to utilize different cryptographic algorithms based on the computational capabilities of the device, selecting more computationally intensive post-quantum cryptographic algorithms on devices with sufficient processing power while falling back to efficient elliptic curve algorithms on resource-constrained devices. This adaptive approach ensures that the account recovery system can operate across a diverse range of computing devices while maximizing the security guarantees provided by each device's available hardware features.

### Account Recovery Process

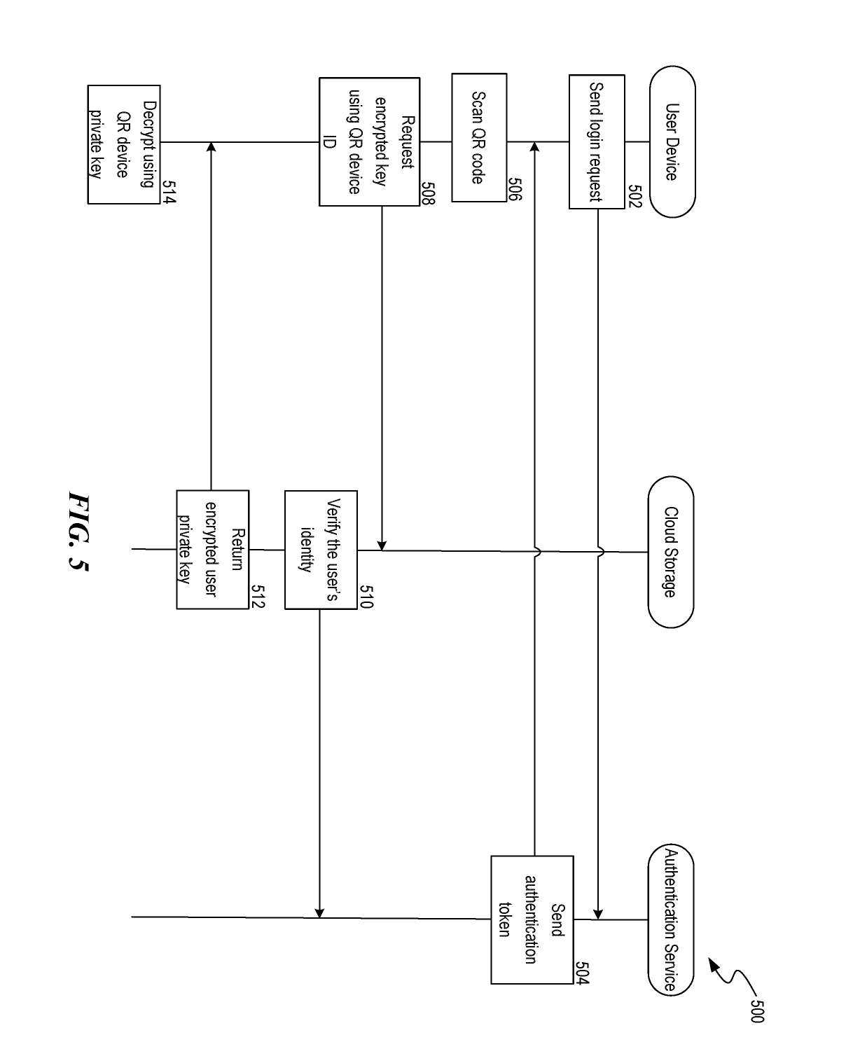

FIG. 5 illustrates a diagram 500 for user re-authentication and account recovery via a QR code in accordance with various embodiments of the present technology. Diagram 500 can illustrate an example of a user accessing an account with a new device if the previous device is, for example, lost or broken. The diagram 500 shows communication between a user device, cloud storage, and an authentication service. This process can enable secure recovery of a user's private key by combining trusted third-party authentication with a physical QR recovery code (e.g., a physical QR recovery code that was previously generated and stored offline). The diagram 500 is illustrated as a series of steps 502-514, which can be executed in accordance with the description above and/or with the description that follows.

At step 502, the new user device (e.g., an unregistered device) sends a login request to the authentication service. This login request can initiate the authentication process by establishing a trusted user identity that can later be reused for authentication after account recovery is complete. The login request can be transmitted using one or more secure communication protocols to protect against potential interception and/or tampering during transit. The authentication service can be a trusted third-party provider, such as OAuth with Google or Apple, that maintains the user's identity credentials independently from the account recovery system. In some implementations, the user may use a different third-party account than the one originally associated with the account, providing flexibility in recovery scenarios where the original authentication credentials are no longer accessible.

At step 504, the authentication service sends an authentication token to the new user device. This authentication token can serve as a temporary credential, allowing the user device to proceed with the account recovery process. The authentication token can have a limited validity period to enhance security and prevent unauthorized reuse of the credential. The token can be cryptographically signed by the authentication service to enable verification of its authenticity by other components in the system. Upon receiving the authentication token, the new user device can store it temporarily in secure memory for use in subsequent steps of the recovery process. If the user has lost access to their original email account, and they are performing account recovery with a new email account, in order to associate their user data repository with this new email account. The service validates both the email account and the QR code before updating the association.

At step 506, the new user device scans the QR code that was previously generated and stored as a physical backup (at step 312 of FIG. 3). For example, a camera of the new user device can capture one or more images of the QR code. The QR code can be associated with, linked to, and/or contain the QR device identifier and the QR device private key, which are essential for the recovery process. The QR device ID from the QR code is used in a server query in order to obtain the encrypted user private key. The QR device private key comes directly from the QR code. The new user device can perform the scanning process using one or more image processing algorithms to decode the QR code data and extract the encoded information from one or more images from a camera of new user device. The image processing algorithms can include, for example, edge detection algorithms, pattern recognition algorithms, contrast enhancement algorithms, noise reduction filters, binarization algorithms, perspective correction algorithms, or other suitable image processing techniques. The new user device can validate the integrity of the extracted data to ensure the QR code has not been corrupted or tampered with before proceeding with the recovery process.

Upon scanning the QR code, at step 508, the new user device requests the encrypted user private key from the cloud storage server using the QR device identifier obtained from or associated with the scanned QR code. This request can allow the cloud storage server to locate the specific encrypted user private key associated with the QR device. The request can also include the authentication token received in step 504 to verify that the requesting device has been authenticated through the trusted third-party service. The cloud storage server can use the QR device identifier to query its database and retrieve the corresponding encrypted user private key that was stored during the initial QR recovery code generation process. In some implementations, the request can be transmitted using encrypted communication channels to protect the QR device identifier during transit.

At step 510, the cloud storage verifies the user’s identity with the authentication service. The authentication service can verify the user’s identity based on the authentication token (from step 504). This verification step ensures that the request for the encrypted key originates from a legitimately authenticated user and prevents unauthorized access to stored cryptographic material. The cloud storage can reject the request and terminate the process if the authentication service indicates that the token is invalid, expired, or has been revoked. Upon successful verification, the cloud storage server can proceed to retrieve the requested encrypted user private key from its database.

At step 512, the cloud storage server sends the encrypted user private key to the new user device. This encrypted key can be the same key that was previously stored during the QR recovery code process described in the method 300. The transmission of the encrypted user private key can be performed using secure communication protocols to maintain the integrity and confidentiality of the data during transit. Since the user private key remains encrypted throughout the transmission, the cloud storage maintains zero-knowledge principles by never accessing or exposing the unencrypted user private key. The encrypted data can only be decrypted by the corresponding QR device private key, which is only available on the new user device after scanning the physical QR code.

Upon receiving the encrypted user private key, at step 514, the new user device decrypts the user private key using the QR device private key obtained from the scanned QR code. This decryption process can occur locally on the user device, ensuring that the unencrypted user private key is never exposed outside of the device. The decryption operation restores the user's private key (e.g., restores the private key to its original form), enabling the user to perform cryptographic operations, such as signing transactions, decrypting user data, modifying data, etc. Following successful decryption, the new user device can securely store the decrypted private key in a dedicated encryption key secure storage area available in modern devices for future use in authentication and cryptographic operations within the system.

The decryption in step 514 can utilize the QR device private key that corresponds to the QR device public key used for encryption during the initial QR recovery code process. By using this QR device-specific key pair, the system can ensure that only a device with access to the physical QR recovery code can decrypt and access the user's private key. This approach maintains end-to-end encryption principles by ensuring that the user's private key is only available in unencrypted form on the authorized user device. The mathematical relationship between the QR device public and private keys ensures that the encryption performed during the QR code generation process can only be reversed by possessing the corresponding private key encoded in the physical QR code.

In some cases, the successful completion of step 514 can grant the user device full access to the user's account and associated data on the new device. The decrypted user private key can be used for various cryptographic operations within the system, such as signing transactions or decrypting user data. Following successful recovery, the new user device can generate its own device-specific key pair and register with the cloud server, enabling future authentication without requiring the QR code. The user can also choose to generate a new QR recovery code on the new device, which may invalidate the previously used QR code depending on system configuration settings. In some embodiments, prior user device(s) can be unauthenticated upon the new authentication to manage the number of authenticated devices.

In some implementations, the system can enforce a limit on the number of authorized devices, number of times new devices are authorized, number of recovery codes associated with a user account, or the like. In some embodiments, the cloud server can maintain a count of active device credentials and QR recovery codes for each user, and when the count reaches a predefined threshold, the system can require the user to deactivate an existing device or recovery code before adding a new one. This limitation can prevent unauthorized proliferation of access credentials and reduce the attack surface by ensuring that only a manageable number of devices can access the user's encrypted private key at any given time. When a user generates a new QR recovery code, the system can automatically deactivate previously generated QR recovery codes by deleting the corresponding encrypted user private keys from the server, ensuring that only the most recently generated recovery code remains valid. In some embodiments, the system can prevent the user from registering new codes until old ones are deleted. In some embodiments, when a user registers a new device that would exceed the authorized device limit, the system can prompt the user to select an existing device for deactivation, after which the server removes the encrypted user private key associated with the deactivated device. This automatic deactivation of old keys ensures that lost or forgotten devices and recovery codes cannot be used for unauthorized access, even if they are later discovered by malicious actors. The user can also manually deactivate specific devices or recovery codes through a credential management interface, providing flexibility in managing access to their account while maintaining the security benefits of limiting the number of active credentials. An account owner can select the number of authorized devices, number of times new devices can be authorized, number of recovery codes associated with the account, etc.

The diagram 500 can illustrate a secure account recovery process that combines trusted third-party authentication with the use of a physical QR recovery code. This approach can provide a robust security model by ensuring that sensitive cryptographic material, such as the user's private key, remains protected throughout the recovery process. The dual-factor security model combines "something you know" (e.g., a trusted online identity) and "something you have" (e.g., a physical QR code) to enable secure recovery without ever exposing the key in unencrypted form on any server. This recovery mechanism accommodates users who may have lost access to their original third-party authentication account, allowing them to recover their data using a new email account in conjunction with the physical QR code.

In some cases, the system can include a method for invalidating device credentials or QR recovery codes if a device or QR code is lost or compromised. The invalidation is implemented in the server by simply deleting the encrypted user private key from the server. As indicated below, this can be triggered by a user request, or by an automatic algorithm. This invalidation process can involve the user notifying the system of the loss or compromise, after which the system can revoke the associated device credentials or QR recovery code. The revocation can prevent any future use of the lost or compromised device or QR code for authentication or recovery purposes, enhancing the overall security of the system.

In some implementations, the system can include security mechanisms to detect and respond to fraudulent recovery attempts. When the cloud storage server receives a request for an encrypted user private key using a QR device identifier, the server can verify that the provided identifier corresponds to a valid and active recovery code in its database. If the server detects that the QR device identifier does not match any stored records, or if the identifier corresponds to a previously invalidated or revoked recovery code, the system can determine that the recovery attempt involves a fake or unauthorized key. Upon detecting such a fraudulent recovery attempt, the system can automatically lock the associated user account to prevent further unauthorized access attempts. The account lock can prevent any additional authentication requests, device registrations, or recovery attempts until the legitimate account owner verifies their identity through an alternative verification process. The system can also log the details of the fraudulent attempt, including timestamps, device information, and network identifiers, to assist in security audits and potential investigation of malicious activity. In some cases, the system can notify the legitimate account owner of the suspicious activity through a registered communication channel, such as an email address or phone number associated with the account, alerting them to the attempted breach and providing instructions for unlocking their account after verification.

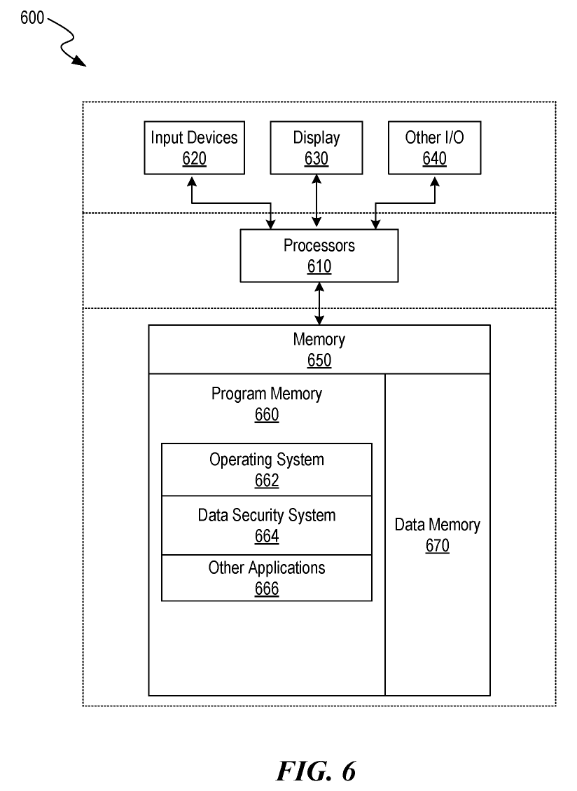

FIG. 6 is a block diagram illustrating an overview of devices on which some implementations of the disclosed technology can operate. The devices can comprise hardware components of a device 600. Device 600 can serve as a user device that generates cryptographic key pairs, encrypts user private keys, and creates QR recovery codes for secure account backup and recovery operations. Device 600 can also function as a new user device during the account recovery process, scanning QR codes, communicating with cloud servers, and performing local decryption of encrypted user private keys to restore account access. Device 600 can include one or more input devices 620 that provide input to the processor(s) 610 (e.g., CPU(s), GPU(s), HPU(s), etc.), notifying it of actions. The actions can be mediated by a hardware controller that interprets the signals received from the input device and communicates the information to the processors 610 using a communication protocol. Input devices 620 include, for example, a mouse, a keyboard, a touchscreen, an infrared sensor, a touchpad, a wearable input device, a camera- or image-based input device, a microphone, or other user input devices.

Processors 610 can be a single processing unit or multiple processing units in a device or distributed across multiple devices. Processors 610 can be coupled to other hardware devices, for example, with the use of a bus, such as a PCI bus or SCSI bus. The processors 610 can communicate with a hardware controller for devices, such as for a display 630. Display 630 can be used to display text and graphics. In some implementations, display 630 provides graphical and textual visual feedback to a user. In some implementations, display 630 includes the input device as part of the display, such as when the input device is a touchscreen or is equipped with an eye direction monitoring system. In some implementations, the display is separate from the input device. Examples of display devices are: an LCD display screen, an LED display screen, a projected, holographic, or augmented reality display (such as a heads-up display device or a head-mounted device), and so on. Other I/O devices 640 can also be coupled to the processor, such as a network card, video card, audio card, USB, firewire or other external device, camera, printer, speakers, CD-ROM drive, DVD drive, disk drive, or Blu-Ray device.

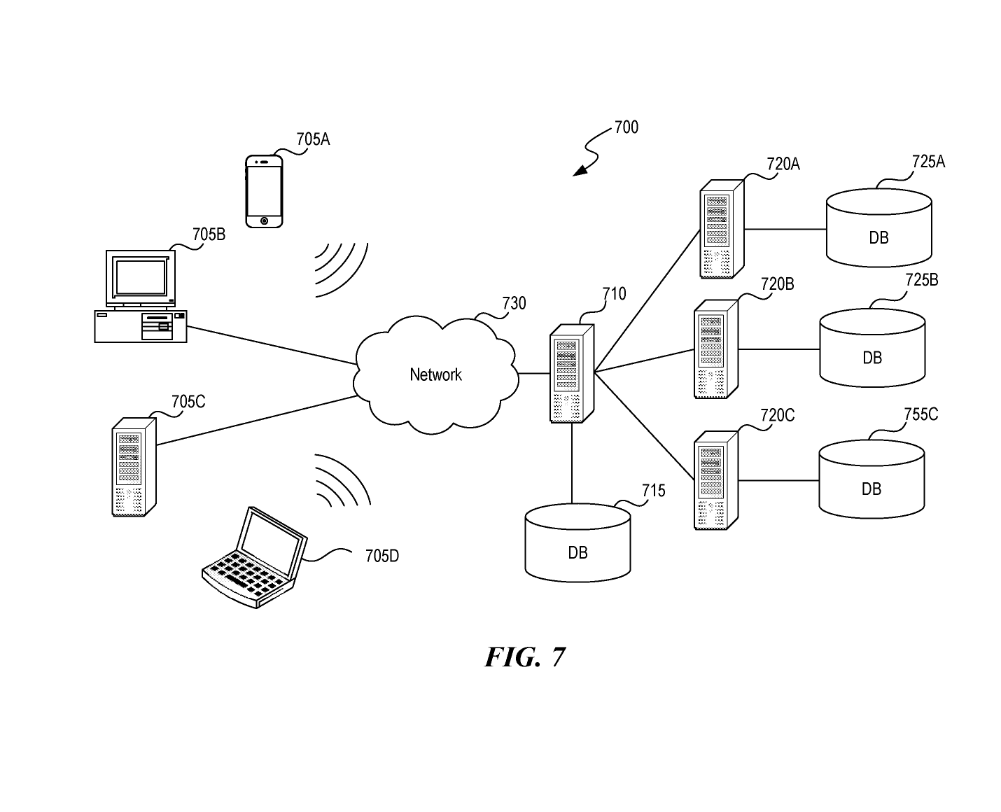

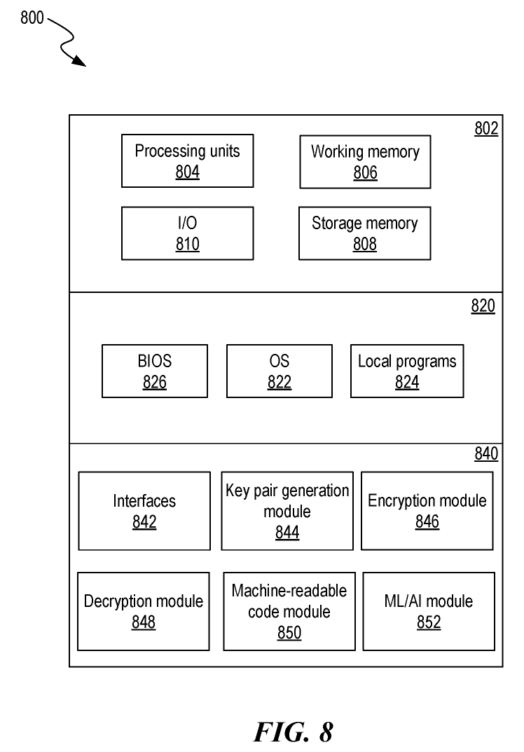

In some implementations, the device 600 also includes a communication device capable of communicating wirelessly or wire-based with a network node. The communication device can communicate with another device or a server through a network using, for example, TCP/IP protocols. Device 600 can utilize the communication device to distribute operations across multiple network devices, such as the network devices of FIGS. 7 and 8.

The processors 610 can have access to a memory 650 in a device or distributed across multiple devices. A memory includes one or more of various hardware devices for volatile and non-volatile storage, and can include both read-only and writable memory. For example, a memory can comprise random access memory (RAM), various caches, CPU registers, read-only memory (ROM), and writable non-volatile memory, such as flash memory, hard drives, floppy disks, CDs, DVDs, magnetic storage devices, tape drives, and so forth. A memory is not a propagating signal divorced from underlying hardware; a memory is thus non-transitory. Memory 650 can include program memory 660 that stores programs and software, such as an operating system 662, data security system 664, and other application programs 666. Memory 650 can also include data memory 670 storing decrypted data, encrypted data, keys, authorized user information, or the like.

Some implementations can be operational with numerous other computing system environments or configurations. Examples of computing systems, environments, and/or configurations that can be suitable for use with the technology include, but are not limited to, personal computers, server computers, handheld or laptop devices, cellular telephones, wearable electronics, tablet devices, multiprocessor systems, microprocessor-based systems, set-top boxes, programmable consumer electronics, network PCs, minicomputers, mainframe computers, distributed computing environments that include any of the above systems or devices, or the like.

FIG. 7 is a block diagram illustrating an overview of an environment 700 in which some implementations of the disclosed technology can operate. Environment 700 can include one or more client computing devices 705A-D, examples of which can include device 600. Client computing devices 705 can operate in a networked environment using logical connections through network 730 to one or more remote computers, such as a server computing device 710.

In some implementations, server 710 can be an edge server which receives client requests and coordinates fulfillment of those requests through other servers, such as servers 720A-C. Server computing devices 710 and 720 can comprise computing systems, such as device 600. Though each server computing device 710 and 720 is displayed logically as a single server, server computing devices can each be a distributed computing environment encompassing multiple computing devices located at the same or at geographically disparate physical locations. In some implementations, each server 720 corresponds to a group of servers.

Client computing devices 705 and server computing devices 710 and 720 can each act as a server or client to other server/client devices. Server 710 can connect to a database 715. Servers 720A-C can each connect to a corresponding database 725A-C. As discussed above, each server 720 can correspond to a group of servers, and each of these servers can share a database or can have their own database. Databases 715 and/or 725 can be access repositories and/or a warehouse (e.g., store) information such as keys, encryption/decryption data. Though databases 715 and 725 are displayed logically as single units, databases 715 and 725 can each be a distributed computing environment encompassing multiple computing devices, can be located within their corresponding server, or can be located at the same or at geographically disparate physical locations.

Network 730 can be a local area network (LAN) or a wide area network (WAN), but can also be other wired or wireless networks. Network 730 can be the Internet or some other public or private network. Client computing devices 705 can be connected to network 730 through a network interface, such as by wired or wireless communication. While the connections between server 710 and servers 720 are shown as separate connections, these connections can be any kind of local, wide area, wired, or wireless network, including network 730 or a separate public or private network.

A user can use a computing device 705 to update stored data using version control and can select authorized individuals who can access the data before and/or after a trigger event (e.g., death of the user). The data can include login data (e.g., login information for social media accounts), account information (bank accounts), estate planning documents (e.g., will, trust documents, etc.), insurance documents, title documents, power of attorney documents, living wills, asset lists, end-of-life documents, instructions for digital assets, durable financial power of attorney document, etc. The user can select authorization levels, data accessible to groups of authorized individuals using computing devices 705, trigger events, automated notification settings, etc. For example, a user can authorize designed beneficiaries to access, via the network 730, relevant documents stored in databases 715 and 725. The user can select groups of authorized individuals, data accessible to respective groups, authorization protocols, privacy settings, or the like. Authorized individuals (e.g., family members, beneficiaries, lawyers, doctors, etc.) can access data to, for example, manage healthcare, distribution of assets, manage trusts, manage or close accounts (e.g., social media accounts, bank account, retirement accounts), or the like. U.S. App. No. 63/744,783, which is incorporated by reference in its entirety, discloses accounts that can be accessed using the systems and technology disclosed herein.

FIG. 8 is a block diagram illustrating components 800 which, in some implementations, can be used in a system employing the disclosed technology. The components 800 include hardware 802, general software 820, and specialized components 840. As discussed above, a system implementing the disclosed technology can use various hardware including processing units 804 (e.g. CPUs, GPUs, APUs, etc.), working memory 806, storage memory 808 (local storage or as an interface to remote storage, such as storage 715 or 725), and input and output devices 810. In various implementations, storage memory 808 can be one or more of: local devices, interfaces to remote storage devices, or combinations thereof. For example, storage memory 808 can be a set of one or more hard drives (e.g., a redundant array of independent disks (RAID)) accessible through a system bus or can be a cloud storage provider or other network storage accessible via one or more communications networks (e.g. a network accessible storage (NAS) device, such as storage 715 or storage provided through another server 720). Components 800 of FIG. 8 can be implemented in a client computing device such as client computing devices 705 of FIG. 7 or on a server computing device, such as server computing device 710 or 720 of FIG. 7.

General software 820 can include various applications including an operating system 822, local programs 824, and a basic input output system (BIOS) 826. Specialized components 840 can be subcomponents of a general software application 820, such as local programs 824. Specialized components 840 can include key pair generation module 844, encryption module 846, decryption module 848, QR code module 850, machine learning module 852, and components which can be used for providing user interfaces, transferring data, and controlling the specialized components, such as interfaces 842. In some implementations, components 800 can be in a computing system that is distributed across multiple computing devices or can be an interface to a server-based application executing one or more of specialized components 840. Although depicted as separate components, specialized components 840 can be logical or other nonphysical differentiations of functions and/or can be submodules or code-blocks of one or more applications. The components 800 can perform different processes disclosed herein.

In some implementations, the key pair generation module 844 is configured to generate user key pairs and device key pairs for use in the account recovery and device authentication processes. The key pair generation module 844 can generate a unique user key pair comprising a public key and a private key during account registration, where the public key is transmitted to a server for storage while the private key remains on the user device. The key pair generation module 844 can also generate device-specific key pairs for each user device that authenticates with the system, as well as recovery key pairs comprising a recovery public key and a recovery private key for QR code-based account recovery. The key pair generation can utilize cryptographic algorithms such as Elliptic Curve Cryptography or post-quantum cryptographic algorithms to create mathematically related public and private keys. The key pair generation module 844 can employ a cryptographically secure random number generator to ensure the uniqueness and unpredictability of the generated key pairs.

In some implementations, the encryption module 846 is configured to perform encryption operations for the account recovery and device authentication processes. The encryption module 846 can encrypt a user private key using a device public key to produce an encrypted user private key that can be transmitted to and stored on a cloud server. The encryption module 846 can also encrypt the user private key using a recovery public key associated with a QR recovery code, enabling secure offline backup of the user's cryptographic credentials. The encryption operations performed by the encryption module 846 occur locally on the user device, ensuring that the unencrypted user private key is never transmitted over a network or exposed to the cloud server. The encryption module 846 can utilize various cryptographic methods, such as Elliptic Curve Cryptography or post-quantum cryptographic algorithms, to perform the encryption operations. By encrypting the user’s private key with different public keys corresponding to different devices or recovery mechanisms, the encryption module 846 enables the system to maintain multiple encrypted backups of the user private key while preserving zero-knowledge principles.

In some implementations, the decryption module 848 is configured to perform decryption operations for the account recovery and device authentication processes. The decryption module 848 can decrypt an encrypted user private key using a device private key stored locally on the user device, thereby restoring the user private key to its original form without exposing it outside the device. The decryption module 848 can also decrypt an encrypted user private key using a recovery private key obtained from a scanned QR code during account recovery operations. When a user scans a machine-readable code to extract a recovery identifier and a recovery private key, the decryption module 848 receives the encrypted user private key from a server and decrypts the encrypted user private key using the recovery private key to restore the user private key. The decryption operations performed by the decryption module 848 occur locally on the user device, ensuring that the unencrypted user private key is never transmitted over a network or exposed to the cloud server. The decryption module 848 can utilize various cryptographic methods, such as Elliptic Curve Cryptography or post-quantum cryptographic algorithms, to perform the decryption operations. By performing decryption locally, the decryption module 848 maintains end-to-end encryption principles and zero-knowledge principles throughout the account recovery and device authentication processes.

In some implementations, the machine-readable code module 850 is configured to generate and process machine-readable codes for account recovery and device authentication operations. The machine-readable code module 850 can generate a machine-readable code, such as a QR code, that encodes a recovery identifier and a recovery private key for secure offline backup of the user's cryptographic credentials. During the QR recovery code generation process, the machine-readable code module 850 receives the recovery identifier and the recovery private key from the key pair generation module 844 and encodes this information into a machine-readable format that can be printed on a physical medium or saved to a portable storage device for offline storage. The machine-readable code module 850 can also process scanned machine-readable codes during account recovery operations by extracting the encoded recovery identifier and recovery private key from the scanned code. When a user scans a previously generated machine-readable code using a camera or other image capture device, the machine-readable code module 850 decodes the captured image to extract the recovery identifier, which is used to request the corresponding encrypted user private key from a server, and the recovery private key, which is provided to the decryption module 848 for local decryption of the encrypted user private key. The machine-readable code module 850 can support various machine-readable code formats, including model 1 QR codes, model 2 QR codes, micro QR codes, IQR codes, or other suitable formats capable of encoding the necessary recovery information.

In some implementations, the ML/AI module 852 is configured to perform machine learning and artificial intelligence operations to enhance the security and functionality of the account recovery and device authentication processes. The ML/AI module 852 can analyze authentication patterns to detect anomalous login attempts or potentially fraudulent recovery requests, enabling the system to flag suspicious activity before granting access to encrypted user private keys. The ML/AI module 852 can also optimize the timing and frequency of prompts for users to generate new QR recovery codes based on usage patterns and risk assessments. In some implementations, the ML/AI module 852 can analyze scanned machine-readable codes to improve image processing accuracy when extracting recovery identifiers and recovery private keys from QR codes captured under varying lighting conditions or at different angles. The ML/AI module 852 can further assist in identifying compromised credentials by monitoring for patterns consistent with unauthorized access attempts across multiple user devices or recovery codes. By integrating machine learning capabilities with the key pair generation module 844, encryption module 846, decryption module 848, and machine-readable code module 850, the ML/AI module 852 can provide adaptive security measures that respond to evolving threat landscapes while maintaining the zero-knowledge principles and end-to-end encryption that protect user private keys throughout the account recovery and device authentication processes.

Those skilled in the art will appreciate that the components illustrated in FIGS. 6-8 described above, and in each of the flow diagrams discussed below, can be altered in a variety of ways. For example, the order of the logic can be rearranged, substeps can be performed in parallel, illustrated logic can be omitted, other logic can be included, etc. In some implementations, one or more of the components described above can execute one or more of the processes described below.

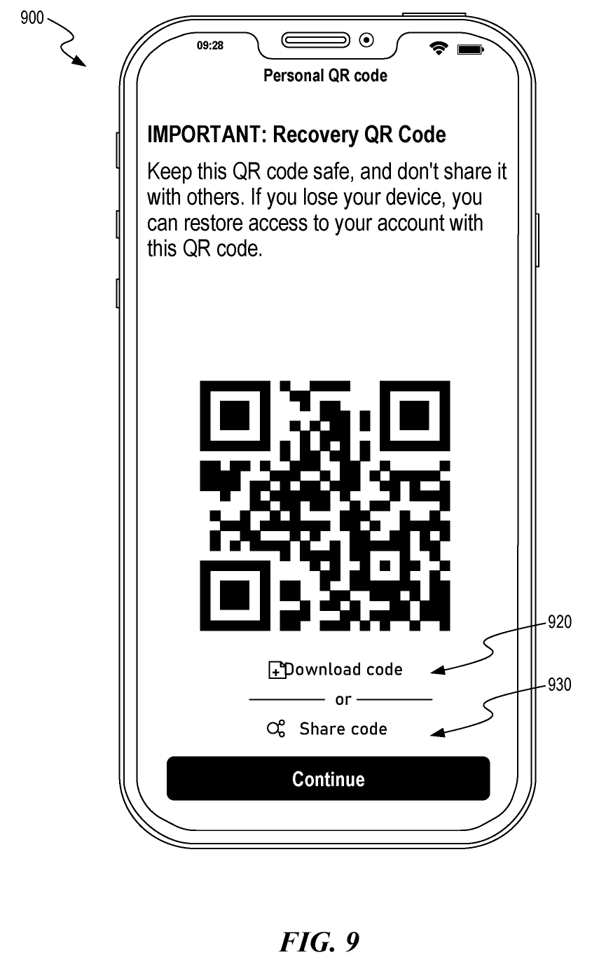

FIG. 9 illustrates a user interface 900 for displaying and managing recovery codes for account access, configured in accordance with various embodiments of the present technology. The user interface 900 can be displayed on a user device, such as a smartphone or tablet, and presents a recovery QR code that encodes the recovery identifier and the recovery private key as described in the account recovery methods of the present technology. The user interface 900 includes instructional text advising the user to keep the QR code safe and explaining that the QR code can be used to restore access to the user's account if the user loses their device. The QR code displayed in the user interface 900 can be a two-dimensional machine-readable bar code and can include a pattern of shapes, such as black and white squares, arranged in a specific configuration that encodes the recovery information. The pattern of shapes can be captured by a camera or other image capture device and decoded by the machine-readable code module 850 to extract the recovery identifier and recovery private key during account recovery operations.

The user interface 900 includes a download button 920 that allows the user to save the QR code to local storage or a portable storage device for offline backup. The user interface 900 also includes a share button 930 that provides an alternative method for the user to export or distribute the QR code, such as sending the QR code to a printer for physical storage or transferring the QR code to another storage medium. By providing the download button 920 and the share button 930, the user interface 900 enables users to store the machine-readable code offline as a physical backup in accordance with the methods described in the present technology. The two-dimensional machine-readable bar code can encode sufficient data capacity to store both the recovery identifier and the recovery private key within the pattern of black and white squares, enabling secure account recovery when the user scans the stored QR code with a new device.

Several implementations of the disclosed technology are described above in reference to the figures. The computing devices on which the described technology can be implemented can include one or more central processing units, memory, input devices (e.g., keyboard and pointing devices), output devices (e.g., display devices), storage devices (e.g., disk drives), and network devices (e.g., network interfaces). The memory and storage devices are computer-readable storage media that can store instructions that implement at least portions of the described technology. In addition, the data structures and message structures can be stored or transmitted via a data transmission medium, such as a signal on a communications link. Various communications links can be used, such as the Internet, a local area network, a wide area network, or a point-to-point dial-up connection. Thus, computer-readable media can comprise computer-readable storage media (e.g., "non-transitory" media) and computer-readable transmission media.

Reference in this specification to "implementations" (e.g. "some implementations," "various implementations," “one implementation,” “an implementation,” etc.) means that a particular feature, structure, or characteristic described in connection with the implementation is included in at least one implementation of the disclosure. The appearances of these phrases in various places in the specification are not necessarily all referring to the same implementation, nor are separate or alternative implementations mutually exclusive of other implementations. Moreover, various features are described which can be exhibited by some implementations and not by others. Similarly, various requirements are described which can be requirements for some implementations but not for other implementations.

As used herein, being above a threshold means that a value for an item under comparison is above a specified other value, that an item under comparison is among a certain specified number of items with the largest value, or that an item under comparison has a value within a specified top percentage value. As used herein, being below a threshold means that a value for an item under comparison is below a specified other value, that an item under comparison is among a certain specified number of items with the smallest value, or that an item under comparison has a value within a specified bottom percentage value. As used herein, being within a threshold means that a value for an item under comparison is between two specified other values, that an item under comparison is among a middle-specified number of items, or that an item under comparison has a value within a middle-specified percentage range. Relative terms, such as high or unimportant, when not otherwise defined, can be understood as assigning a value and determining how that value compares to an established threshold. For example, the phrase "selecting a fast connection" can be understood to mean selecting a connection that has a value assigned corresponding to its connection speed that is above a threshold.

Unless explicitly excluded, the use of the singular to describe a component, structure, or operation does not exclude the use of plural such components, structures, or operations. As used herein, the word "or" refers to any possible permutation of a set of items. For example, the phrase "A, B, or C" refers to at least one of A, B, C, or any combination thereof, such as any of: A; B; C; A and B; A and C; B and C; A, B, and C; or multiple of any item such as A and A; B, B, and C; A, A, B, C, and C; etc.

As used herein, the expression “at least one of A, B, and C” is intended to cover all permutations of A, B and C. For example, that expression covers the presentation of at least one A, the presentation of at least one B, the presentation of at least one C, the presentation of at least one A and at least one B, the presentation of at least one A and at least one C, the presentation of at least one B and at least one C, and the presentation of at least one A and at least one B and at least one C.

The above detailed descriptions of embodiments of the technology are not intended to be exhaustive or to limit the technology to the precise form disclosed above. Although specific embodiments of, and examples for, the technology are described above for illustrative purposes, various equivalent modifications are possible within the scope of the technology, as those skilled in the relevant art will recognize. For example, while steps are presented in a given order, alternative embodiments can perform steps in a different order. Features from various systems, features, and software can be combined with features disclosed in U.S. App. No. 63/744,783, entitled METHODS AND SYSTEMS FOR SECURE DATA STORAGE BASED ON VERSION CONTROL AND ZERO TRUST PRINCIPLES; U.S. App. No. 19/441,377, entitled ESTATE PLANNING PLATFORM WITH VERSION CONTROL AND ZERO TRUST SECURITY which are incorporated by reference in their entireties. For example, the QR code technology disclosed herein can be used for account recovery, device authentication, and other actions associated with accounts, devices, and systems disclosed in U.S. App. No. 63/744,783 and U.S. App. No. 19/441,377. All patents and patent applications referenced herein are incorporated by reference in their entireties.

Although the subject matter has been described in language specific to structural features and/or methodological acts, it is to be understood that the subject matter defined in the appended claims is not necessarily limited to the specific features or acts described above. Specific embodiments and implementations have been described herein for purposes of illustration, but various modifications can be made without deviating from the scope of the embodiments and implementations. The specific features and acts described above are disclosed as example forms of implementing the claims that follow. Accordingly, the embodiments and implementations are not limited except as by the appended claims.

Any patents, patent applications, and other references noted above are incorporated herein by reference. Aspects can be modified, if necessary, to employ the systems, functions, and concepts of the various references described above to provide yet further implementations. If statements or subject matter in a document incorporated by reference conflicts with statements or subject matter of this application, then this application shall control.

What is claimed is:

1. A method for account recovery using a machine-readable code, the method comprising:
generating, by a user device, a recovery key pair comprising a recovery public key and a recovery private key;
encrypting, by the user device, a user private key using the recovery public key to produce an encrypted user private key;
transmitting, by the user device, the recovery public key, the encrypted user private key, and a recovery identifier to a server, wherein the server stores the encrypted user private key in association with the recovery identifier;
generating, by the user device, the machine-readable code encoding the recovery identifier and the recovery private key; and
storing the machine-readable code offline as a physical backup.

2. The method of claim 1, further comprising
authenticating the user device based on the machine-readable code stored offline;
accessing, using the authenticated user device, an account stored by a remote computer system; and
obtaining, using the authenticated user device, data from the account based on one or more accessibility settings for a user associated with the authenticated user device.

3. The method of claim 1, further comprising:
scanning, by a device, the machine-readable code to extract the recovery identifier and the recovery private key, wherein the device is different than the user device;
requesting, by the device, the encrypted user private key from the server using the recovery identifier;
receiving, by the device, the encrypted user private key from the server; and
decrypting, by the device, the encrypted user private key using the recovery private key to restore the user private key.

4. The method of claim 3, further comprising:
authenticating, by the device, with a third-party authentication service prior to requesting the encrypted user private key from the server; and
verifying, by the server, the authentication with the third-party authentication service before transmitting the encrypted user private key to the device.

5. The method of claim 1, further comprising:
sending, by the user device, a login request to a third-party authentication service;
receiving, by the user device, an authentication token from the third-party authentication service;
transmitting, by the user device, a request for the encrypted user private key to enable the server to verify the authentication, wherein the request includes the authentication token;
receiving, by the user device, the encrypted user private key from the server; and
decrypting, by the user device, the encrypted user private key using the recovery private key to restore the user private key.

6. The method of claim 5, wherein verifying the authentication comprises the server communicating with the third-party authentication service to validate the authentication token before transmitting the encrypted user private key to the user device.

7. The method of claim 1, wherein the machine-readable code comprises a quick-response (QR) code, wherein storing the machine-readable code offline comprises at least one of printing the machine-readable code on a physical medium or saving the machine-readable code to a portable storage device, and wherein the recovery identifier is generated by the server to ensure uniqueness across a plurality of user devices.

8. A system comprising:
one or more processors; and
one or more memories storing instructions that, when executed by the one or more processors, cause the system to perform a process for account recovery using a machine-readable code, the process comprising:
generating, by a user device, a recovery key pair comprising a recovery public key and a recovery private key;
encrypting, by the user device, a user private key using the recovery public key to produce an encrypted user private key;
transmitting, by the user device, the recovery public key, the encrypted user private key, and a recovery identifier to a server, wherein the server stores the encrypted user private key in association with the recovery identifier;
generating, by the user device, the machine-readable code encoding the recovery identifier and the recovery private key; and
storing the machine-readable code offline as a physical backup.

9. The system of claim 8, wherein the process further comprises:
authenticating the user device based on the machine-readable code stored offline;
accessing, using the authenticated user device, an account stored by a remote computer system; and
obtaining, using the authenticated user device, data from the account based on one or more accessibility settings for a user associated with the authenticated user device.

10. The system of claim 8, wherein the process further comprises:
scanning, by a device, the machine-readable code to extract the recovery identifier and the recovery private key, wherein the device is different than the user device;
requesting, by the device, the encrypted user private key from the server using the recovery identifier;
receiving, by the device, the encrypted user private key from the server; and
decrypting, by the device, the encrypted user private key using the recovery private key to restore the user private key.

11. The system of claim 10, wherein the process further comprises:
authenticating, by the device, with a third-party authentication service prior to requesting the encrypted user private key from the server; and
verifying, by the server, the authentication with the third-party authentication service before transmitting the encrypted user private key to the device.

12. The system of claim 8, wherein the process further comprises:
sending, by the user device, a login request to a third-party authentication service;
receiving, by the user device, an authentication token from the third-party authentication service;
transmitting, by the user device, a request for the encrypted user private key to enable the server to verify the authentication, wherein the request includes the authentication token;
receiving, by the user device, the encrypted user private key from the server; and
decrypting, by the user device, the encrypted user private key using the recovery private key to restore the user private key.

13. The system of claim 12, wherein verifying the authentication comprises the server communicating with the third-party authentication service to validate the authentication token before transmitting the encrypted user private key to the user device.

14. The system of claim 8, wherein the machine-readable code comprises a quick-response (QR) code, wherein storing the machine-readable code offline comprises at least one of printing the machine-readable code on a physical medium or saving the machine-readable code to a portable storage device, and wherein the recovery identifier is generated by the server to ensure uniqueness across a plurality of user devices.

15. A non-transitory computer-readable medium storing instructions that, when executed by a computing system, cause the computing system to perform operations for account recovery using a machine-readable code, the operations comprising:
generating, by a user device, a recovery key pair comprising a recovery public key and a recovery private key;
encrypting, by the user device, a user private key using the recovery public key to produce an encrypted user private key;
transmitting, by the user device, the recovery public key, the encrypted user private key, and a recovery identifier to a server, wherein the server stores the encrypted user private key in association with the recovery identifier;
generating, by the user device, the machine-readable code encoding the recovery identifier and the recovery private key; and
storing the machine-readable code offline as a physical backup.

16. The non-transitory computer-readable medium of claim 15, wherein the operations further comprise:
authenticating the user device based on the machine-readable code stored offline;
accessing, using the authenticated user device, an account stored by a remote computer system; and
obtaining, using the authenticated user device, data from the account based on one or more accessibility settings for a user associated with the authenticated user device.

17. The non-transitory computer-readable medium of claim 15, wherein the operations further comprise:
scanning, by a device, the machine-readable code to extract the recovery identifier and the recovery private key, wherein the device is different than the user device;
requesting, by the device, the encrypted user private key from the server using the recovery identifier;
receiving, by the device, the encrypted user private key from the server; and
decrypting, by the device, the encrypted user private key using the recovery private key to restore the user private key.

18. The non-transitory computer-readable medium of claim 17, wherein the operations further comprise:
authenticating, by the device, with a third-party authentication service prior to requesting the encrypted user private key from the server; and
verifying, by the server, the authentication with the third-party authentication service before transmitting the encrypted user private key to the device.

19. The non-transitory computer-readable medium of claim 15, wherein the operations further comprise:
sending, by the user device, a login request to a third-party authentication service;
receiving, by the user device, an authentication token from the third-party authentication service;
transmitting, by the user device, a request for the encrypted user private key to enable the server to verify the authentication, wherein the request includes the authentication token;
receiving, by the user device, the encrypted user private key from the server; and
decrypting, by the user device, the encrypted user private key using the recovery private key to restore the user private key.

20. The non-transitory computer-readable medium of claim 19,
wherein verifying the authentication comprises the server communicating with the third-party authentication service to validate the authentication token before transmitting the encrypted user private key to the user device,
wherein the machine-readable code comprises a quick-response (QR) code,
wherein storing the machine-readable code offline comprises at least one of printing the machine-readable code on a physical medium or saving the machine-readable code to a portable storage device, and
wherein the recovery identifier is generated by the server to ensure uniqueness across a plurality of user devices.
